(19) United States
(12) Patent Application Publication
(10) Pub. No.: US 2025/0384295 A1
(43) Pub. Date: Dec. 18, 2025

(54) TECHNIQUES FOR IMPLEMENTING MULTIMODAL LARGE LANGUAGE MODELS WITH MIXTURES OF VISION ENCODERS

(71) Applicant: NVIDIA CORPORATION, Santa Clara, CA (US)

(72) Inventors: Guilin LIU, San Jose, CA (US); Zhiding YU, Santa Clara, CA (US); Min SHI, Wuhan City (CN); Fuxiao LIU, Baltimore, MD (US); Shihao WANG, Beijing (CN); Shijia LIAO, Santa Clara, CA (US); Subhashree RADHAKRISHNAN, San Jose, CA (US); De-An HUANG, Davis, CA (US); Hongxu YIN, San Jose, CA (US); Karan SAPRA, San Jose, CA (US); Bryan CATANZARO, Los Altos Hills, CA (US); Andrew J. TAO, San Francisco, CA (US); Jan KAUTZ, Lexington, MA (US)

(21) Appl. No.: 19/172,564

(22) Filed: Apr. 7, 2025

Related U.S. Application Data
(60) Provisional application No. 63/660,949, filed on Jun. 17, 2024.

(51) Int. Cl. G06N 3/0985; G06N 3/045

(52) U.S. Cl. CPC G06N 3/0985; G06N 3/045

(57) ABSTRACT

The disclosed method for training multimodal models includes performing one or more operations to train a plurality of vision language models to generate a plurality of trained vision language models, where each trained vision language model included in the plurality of trained vision language models comprises a different vision encoder and a first language model, and performing one or more operations to train a multimodal model to generate a trained multimodal model, where the trained multimodal model comprises the different vision encoders and a second language model.

### CROSS-REFERENCE TO RELATED APPLICATIONS

This application claims priority benefit of the United States Provisional Patent Application titled, “MULTIMODAL LARGE LANGUAGE MODELS WITH MIXED VISION ENCODERS,” filed on Jun. 17, 2024, and having Ser. No. 63/660,949. The subject matter of this related application is hereby incorporated herein by reference.

### BACKGROUND

### Technical Field

Embodiments of the present disclosure relate generally to computer science, artificial intelligence, and machine learning, and more specifically, to techniques for implementing multimodal large language models with mixtures of vision encoders.

### Description of the Related Art

Multimodal large language models (MLLMs) are machine learning models designed to process and generate information across multiple types of data, such as text and images. MLLMs are unlike traditional language models, which can only process text and generate text outputs. The ability to understand and relate information from different modalities enables MLLMs to be applied to sophisticated applications, such as virtual assistants, content creation tools, automated medical diagnostics, image-based search, visual question answering, recommendation engines, augmented reality experiences, medical diagnosis support, content moderation, and robotics, among other things.

Conventional MLLMs build upon large language models (LLMs) by processing and integrating multiple types of data through specialized components, including modality-specific encoders and an LLM. The encoders are preprocessing units that transform raw inputs, such as images and text, into structured representations that can be understood by the LLM. Then, the LLM can process the structured representations to generate outputs, infer relationships between modalities, and perform reasoning tasks, among other things.

One drawback of the above approach for implementing MLLMs that can process text and image data is that the MLLMs tend to ignore smaller details in images that are input into the MLLMs. In particular, the MLLMs oftentimes fail to perceive and/or understand smaller details. As a result, the MLLMs can generate outputs that are incorrect for those images and text that are input into the MLLMs. For example, an MLLM could respond incorrectly or “hallucinate” an answer to a text question about an image that is input into the MLLM. As another example, an MLLM could fail to correctly perform various tasks, such as optical character recognition (OCR) or document analysis.

As the foregoing illustrates, what is needed in the art are more effective techniques for implementing MLLMs.

### SUMMARY

One embodiment of the present disclosure sets forth a computer-implemented method for training multimodal models. The method includes performing one or more operations to train a plurality of vision language models to generate a plurality of trained vision language models. Each trained vision language model included in the plurality of trained vision language models comprises a different vision encoder and a first language model. The method further includes performing one or more operations to train a multimodal model to generate a trained multimodal model. The trained multimodal model comprises the different vision encoders and a second language model.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, MLLMs can be trained to perceive and understand smaller details in images that are input into the MLLMs. In addition, the trained MLLMs can generate, for images and text that are input into the MLLMs, more correct outputs relative to what can be generated by conventional MLLMs. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the multimodal large language model (MLLM) of FIG. 1, according to various embodiments;

FIG. 5A is a more detailed illustration of the fusion module of FIG. 4, according to various embodiments;

FIG. 5B is a more detailed illustration of the fusion module of FIG. 4, according to various other embodiments;

FIGS. 6A-6C illustrate how a MLLM that includes a mixture of vison encoders can be trained, according to various embodiments;

FIG. 7 is a more detailed illustration of the model generator of FIG. 1, according to various embodiments;

FIG. 8 is a flow diagram of method steps for training a MLLM that includes a mixture of vision encoders, according to various embodiments;

FIG. 9 is a flow diagram of method steps for generating a family of MLLMs that include different numbers of vision encoders, according to various embodiments; and

FIG. 10 is a flow diagram of method steps for processing inputs using a trained MLLM that includes a mixture of vision encoders, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating and training multimodal large language models (MLLMs) that include a mixture of vision encoders. In some embodiments, a model trainer trains a MLLM that includes multiple vision encoders, which can be pre-trained for different tasks and image sizes, in three stages. In the first stage, referred to herein as “pre-alignment training,” the model trainer performs, using a captioning dataset and an instruction following dataset as training data, training of multiple vision-language models that each include a different vision encoder and the same large language model (LLM). The training in the first stage can include updating parameters of the different vision encoders, while keeping parameters of the LLM fixed. In the second stage, referred to herein as “joint-projector training,” the model trainer trains a MLLM that includes the different vision encoders and another LLM using the captioning dataset and the instruction following dataset as training data. The training in the second stage can include updating parameters of the different vision encoders and a projector that projects vision features output by the vision encoders to language embedding tokens in a word embedding space of the LLM, while keeping parameters of a tokenizer and the LLM fixed. In the third stage, referred to herein as “supervised fine-tuning,” the model trainer trains the MLLM using the instruction following dataset as training data. The training in the third stage can include updating parameters of the vision encoders, the projector, the large language model, and the tokenizer.

In some embodiments, a model generator generates a family of MLLMs that include different numbers of vision encoders using a round robin search. In the round robin search, the model generator first selects, from a set of vision encoders, a vision encoder that has not yet been considered. The model generator computes a performance score for a combination of the selected encoder with a current MLLM, if any. In some embodiments, the selection can be performed prior to training, and the performance score is computed after the MLLM that includes the combination of the selected encoder and the current MLLM is trained. The current MLLM will include a combination of vision encoders that were previously determined to perform the best when used together in a MLLM. If the performance score computed by the model generator is better than the performance score of a best performing combination of any previously considered vision encoder with the current MLLM, then the model generator saves the combination of the selected encoder with the current MLLM as the best performing combination. The foregoing steps are repeated to consider all combinations of vision encoders in the set of vision encoders with the current MLLM to identify a best performing combination. The best performing combination can then be saved as the current MLLM, and the selected vision encoder that was used to generate the best performing combination can be removed from the set of vision encoders. Then, the model generator considers all combinations of vision encoders remaining in the set of vision encoders with the new current MLLM to identify another best performing combination, etc. By repeating the foregoing steps, the model generator can generate a family of best performing MLLMs that include different numbers of vision encoders. In some embodiments, the stopping condition for the round robin search can be when a best performing MLLM that includes more vision encoders performs worse than a best performing MLLM that includes fewer vision encoders, or when all of the vision encoders have been considered and used in the family of MLLMs. One or more of the MLLMs in the family of MLLMs can then be deployed to various applications depending on, e.g., the available computing resources.

The techniques for generating and training MLLMs that include mixtures of vision encoders have many real-world applications. For example, those techniques could be used in virtual assistants, content creation tools, automated medical diagnostics, image-based search, visual question answering, recommendation engines, augmented reality experiences, medical diagnosis support, content moderation, and robotics, among other things.

The above examples are not in any way intended to be limiting. As persons skilled in the art will appreciate, as a general matter, the techniques for generating and training MLLMs that include mixtures of vision encoders can be implemented in any suitable application.

### System Overview

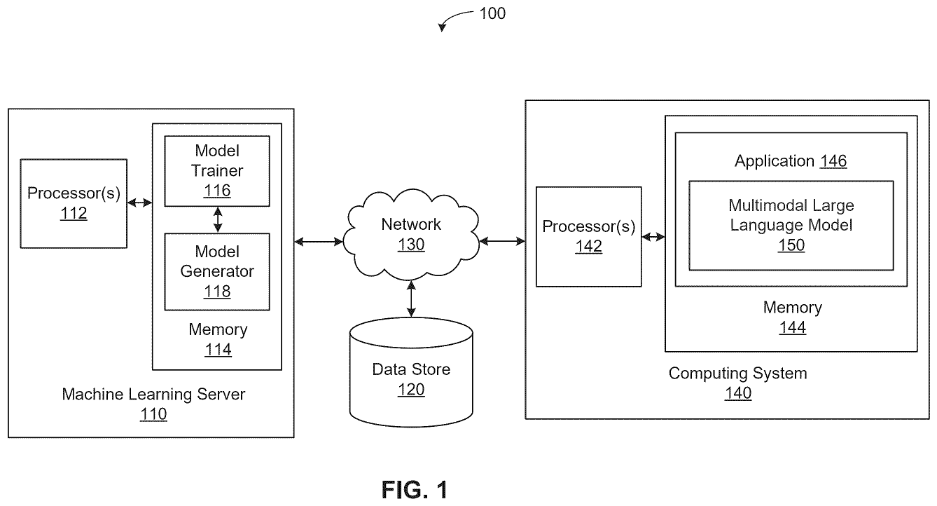

FIG. 1 illustrates a block diagram of a computer-based system 100 configured to implement one or more aspects of at least one embodiment. As shown, the system 100 includes, without limitation, a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 and a model generator 118 execute on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

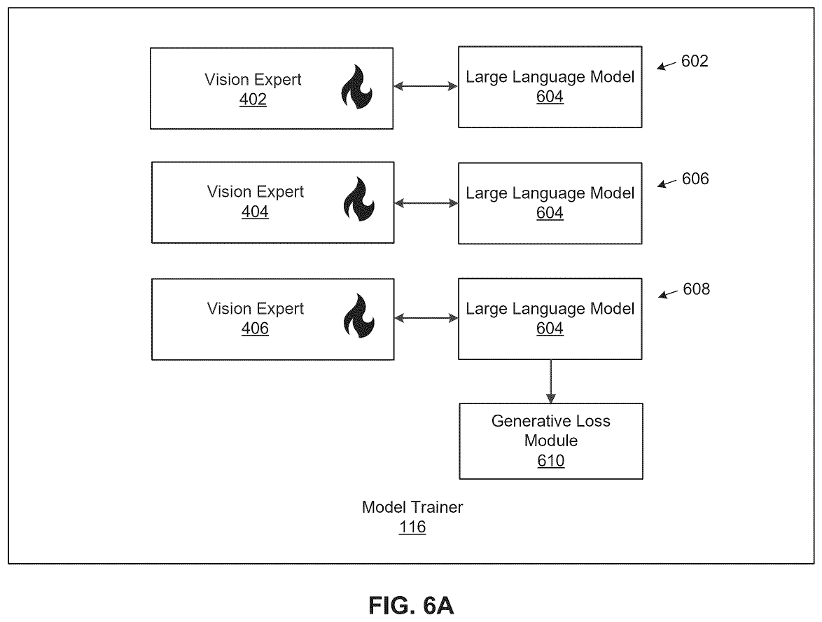

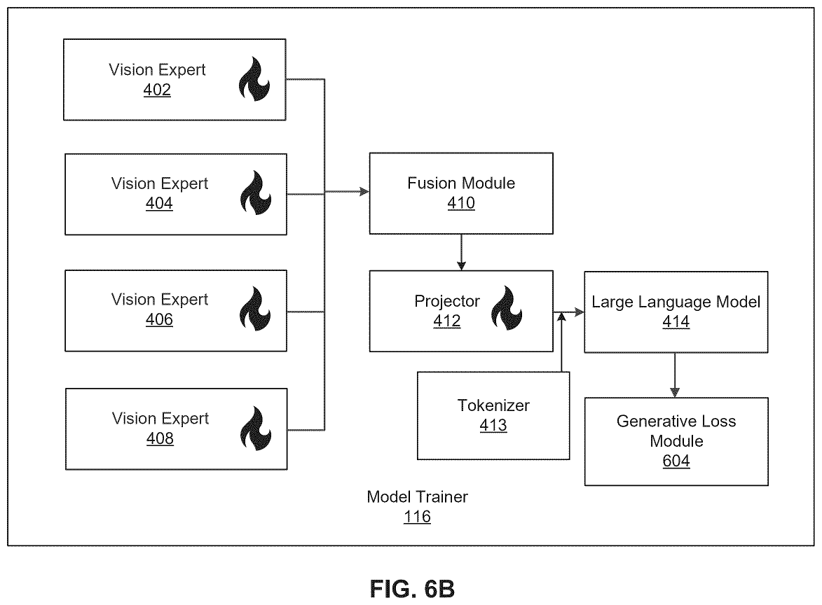

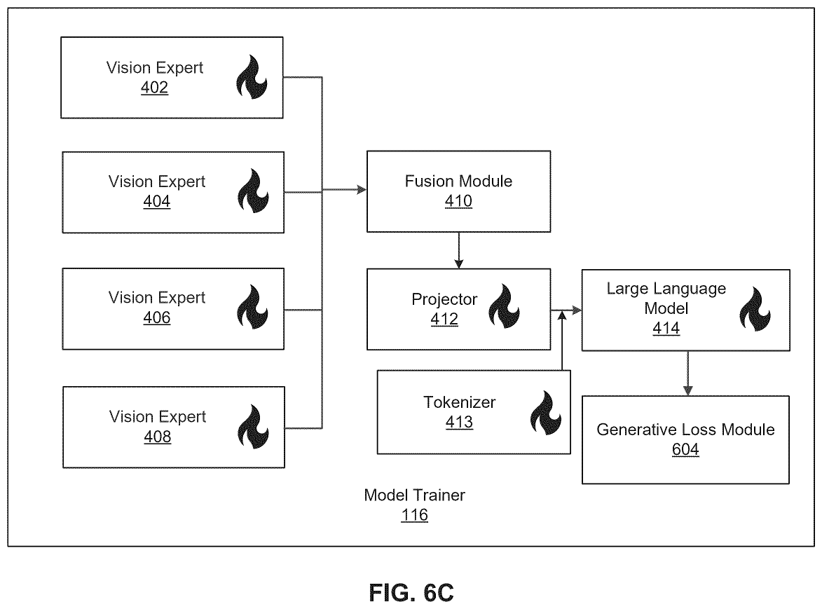

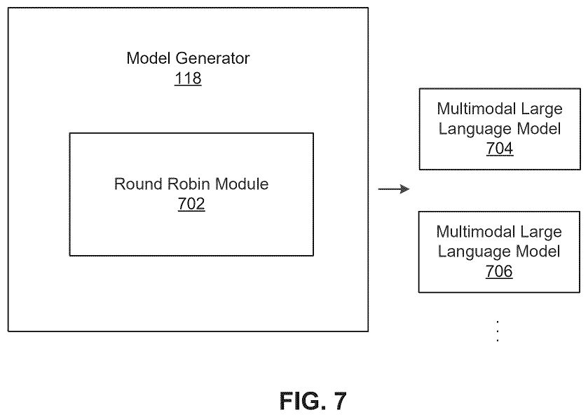

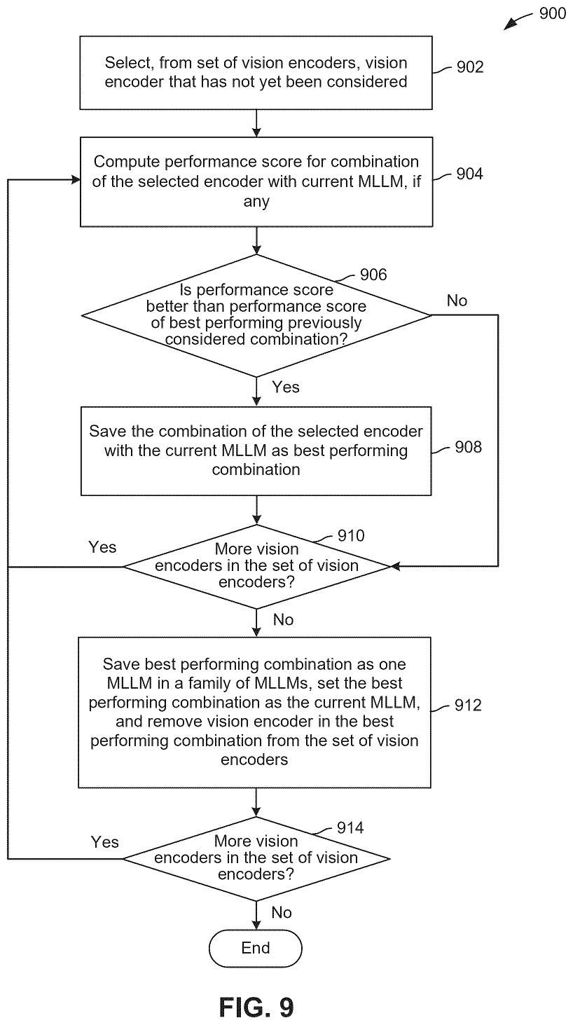

In some embodiments, the model trainer 116 is configured to train one or more machine learning models, including a multimodal large language model (MLLM) 150 that is trained to process text and image inputs. Techniques for generating and training MLLMs are discussed in greater detail below in conjunction with FIGS. 6A-10. In some embodiments, the model generator 118 is configured to perform a round-robin search technique to generate a family of MLLMs that include different numbers of vision encoders, as discussed in greater detail below in conjunction with FIGS. 7 and 9. Training data and/or trained machine learning models, including the MLLM 150, can be stored in the data store 120, or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

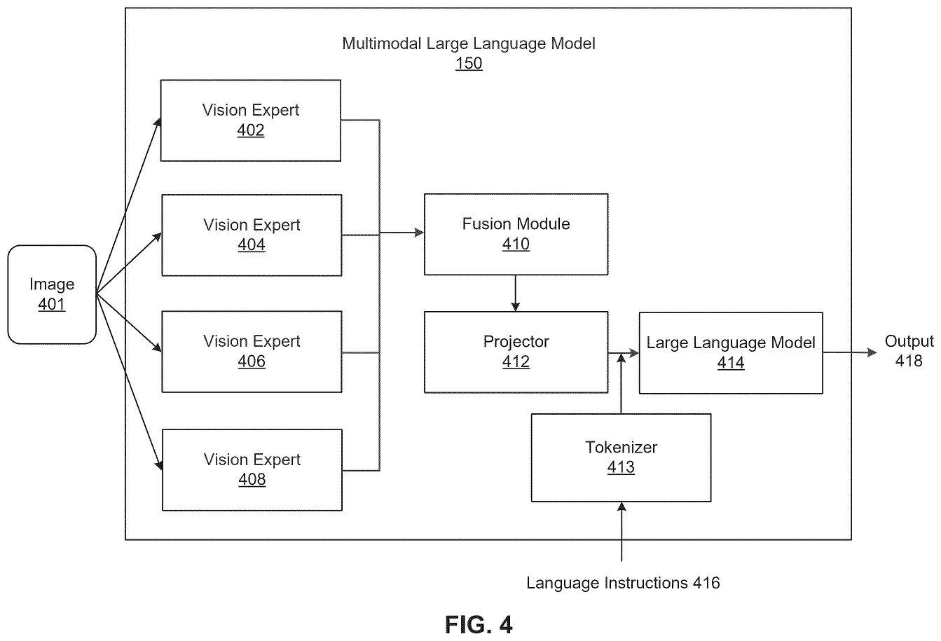

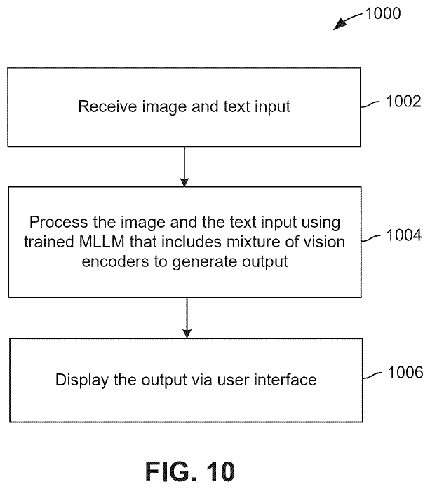

As shown, an application 146 that includes the trained MLLM 150 is stored in a memory 144, and executes on processor(s) 142, of the computing device 140. The memory 144 and the processor(s) 142 may be similar to the memory 114 and the processor(s) 112, respectively, of the machine learning server, described above. In some embodiments, the application 146 can be any technically feasible application that uses the trained MLLM 150. For example, the application 146 could be an application for a virtual assistant, content creation tool, automated medical diagnostic, image-based search, visual question answering, recommendation engine, augmented reality experience, medical diagnosis support, content moderation, robotics, etc. The application 146 is discussed in greater detail below in conjunction with FIGS. 4 and 10.

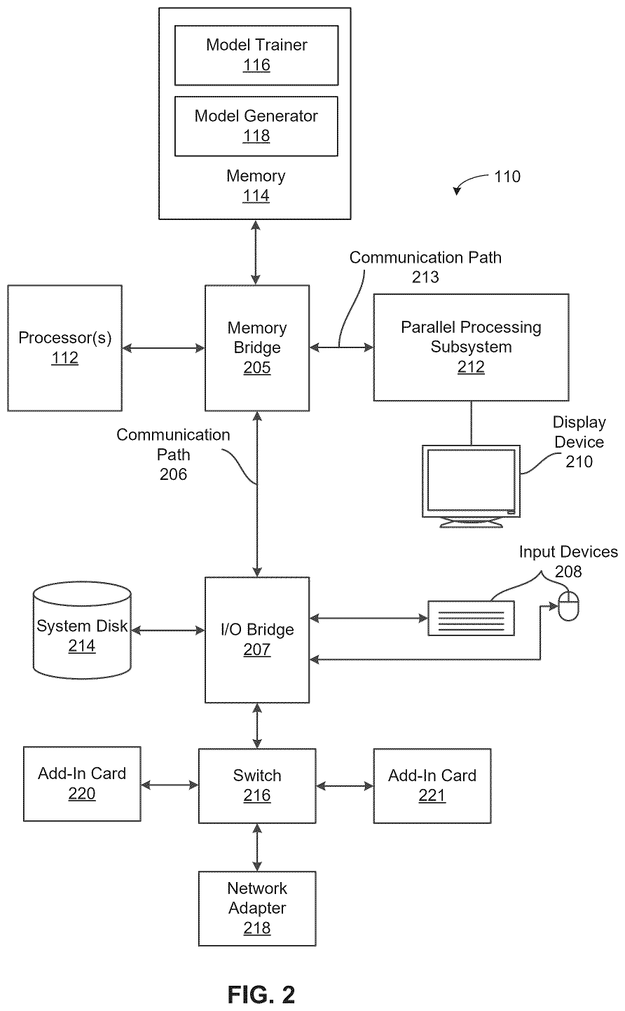

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network. In some embodiments, the machine learning server 110 can include one or more similar components as the machine learning server 110.

In various embodiments, the machine learning server 110 includes, without limitation, the processor(s) 112 and the memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the model trainer 116 and the model generator 118. Although described herein primarily with respect to the model trainer 116 and the model generator 118, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

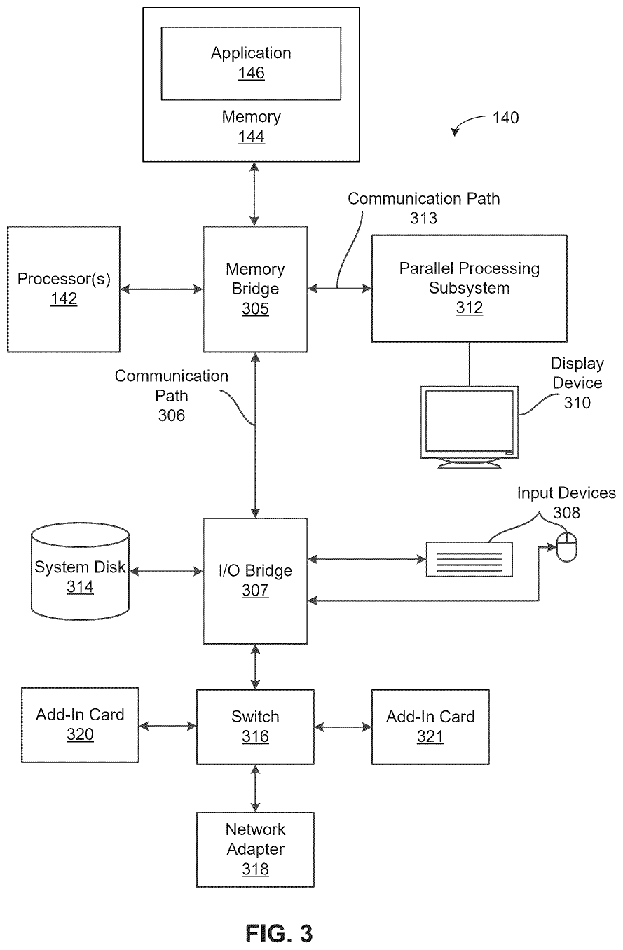

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, the system memory 144 includes the Application 146. Although described herein primarily with respect to the Application 146, techniques disclosed herein can also be implemented, either entirely or in part, in other software and/or hardware, such as in the parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

Multimodal Large Language Models with Mixtures of Vision Encoders

FIG. 4 is a more detailed illustration of the MLLM 150 of FIG. 1, according to various embodiments. As shown, the MLLM 150 includes, without limitation, four vision experts 402, 404, 406, and 408; a fusion module 410; a projector 412; a tokenizer 413; and an LLM 414. In some embodiments, the MLLM 150 can be implemented as an artificial neural network that includes multiple layers of neurons. Although four vision experts 402, 404, 406, and 408 that are vision encoders are shown for illustrative purposes, an MLLM can include any number of vision encoders in some embodiments. Although described herein primarily with respect to MLLMs that include LLMs as a reference example, in some embodiments, techniques disclosed herein can be applied to other multimodal models, including multimodal models that include other types of language models that are capable of processing natural language inputs and generating natural language outputs.

In operation, the MLLM 150 can receive as input an image, shown as image 401, and/or natural language text, shown as language instructions 416. Illustratively, the vision experts 402, 404, 406, and 408 encode the input image 401 into vision features. The fusion module 410 fuses the vision features, and the projector 412 converts the fused vision features into language embedding tokens in a word embedding space of the LLM 414. Separately, the tokenizer 413 tokenizes the language instructions 416 into additional language embedding tokens in the word embedding space. The language embedding tokens output by the projector 412 and the tokenizer 413 are input into the LLM 414, which generates a natural language output 418. In some embodiments, the language embedding tokens output by the projector 412 and the tokenizer 413 can be concatenated and then input into the LLM 414.

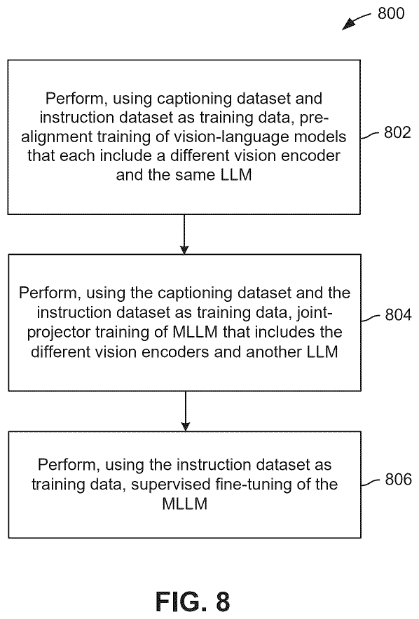

Each of the vision experts 402, 404, 406, and 408 is a pre-trained vision encoder for a specific task. The vision experts 402, 404, 406, and 408 are included in the MLLM 150 to allow the LLM 414 to “see.” Given an image (e.g., the image 401) as input, each of the vision experts 402, 404, 406, and 408 outputs vision features. In some embodiments, the vision experts 402, 404, 406, and 408 can be pre-trained for different tasks, such as a vision language alignment task, a text recognition task, an object detection task, a semantic segmentation task, and/or an optical character recognition (OCR) task, and the vision experts 402, 404, 406, and 408 can also be pre-trained to process images having the same or different resolutions. The multiple vision experts 402, 404, 406, and 408 that are pre-trained for different tasks can perform better for such pre-trained tasks when used in the MLLM 150. Accordingly, the MLLM 150 that uses the vision experts 402, 404, 406, and 408 can perform better across the different tasks than an MLLM that includes only a single vision encoder. In addition, use of multiple vision experts 402, 404, 406, and 408 can enable the MLLM 150 to process large image inputs having high resolution if one or more of the vision experts 402, 404, 406, and 408 were pre-trained to process such large image inputs. In some embodiments, the pre-trained vision experts 402, 404, 406, and 408 can be trained again during a pre-alignment training of vision-language models that each include a different vision encoder and the same LLM, as well as during joint-projector training of a MLLM that includes the different vision encoders and another LLM and supervised fine-tuning of the MLLM, as discussed in greater detail below in conjunction with FIGS. 6A-6C and 8.

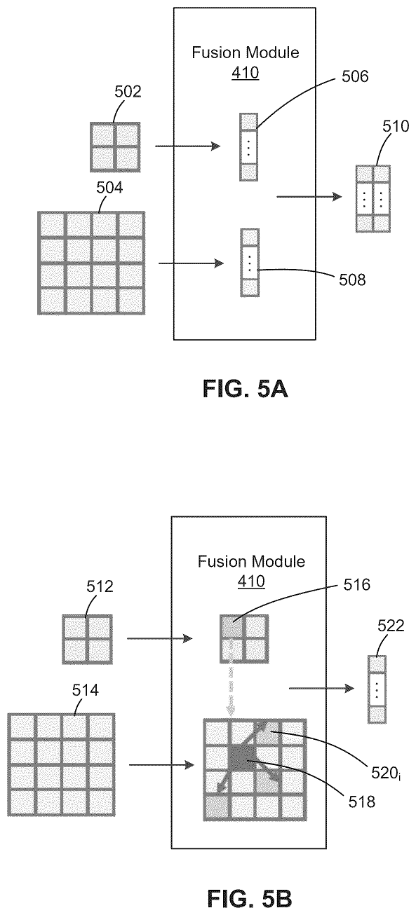

The fusion module 410 fuses the vision features that are output by the vision experts 402, 404, 406, and 408. In some embodiments, the fusion module 410 can perform a channel-wise concatenation of the vision features that are output by the vision experts 402, 404, 406, and 408, as discussed in greater detail below in conjunction with FIG. 5A. In some other embodiments, the fusion module 410 can compute a deformable attention based on the vision features that are output by the vision experts 402, 404, 406, and 408, as discussed in greater detail below in conjunction with FIG. 5B.

The projector 412 converts the fused vision features into language embedding tokens in a word embedding space of the MLLM 150. In some embodiments, the projector 412 can be implemented as a learnable multi-layer perceptron (MLP) layer. In some embodiments, the projector 412 can be trained during joint-projector training of the MLLM 150 and during supervised fine-tuning of the MLLM 150, as discussed in greater detail below in conjunction with FIGS. 6A-6C and 8.

The tokenizer 413 takes as input text and converts the text into language embedding tokens in the embedding space of the MLLM 150. The LLM 414 can understand and process the language embedding tokens. In some embodiments, the language embedding tokens output by the projector 412 are concatenated with the language embedding tokens output by the tokenizer 413, and the concatenated language embedding tokens are input into the LLM 414.

The LLM 414 is a machine learning model configured to process and generate natural language text. The LLM 414 can include a deep learning architecture, such as a transformer-based neural network, that analyzes and predicts language patterns, enabling applications like natural language understanding, text generation, and contextual reasoning. In some embodiments, the LLM 414 can be pre-trained on diverse textual corpora. Given the language embedding tokens output by the projector 412 and the language embedding tokens output by the tokenizer 413, the LLM 414 generates a natural language output (e.g., output 418).

The MLLM 150 can be deployed for use in any technically feasible application, such as the application 146 of FIG. 1. When the application 146 receives an image and a text input, such as an instruction or question, the application 146 inputs the image and text input into the MLLM 150. Given such inputs, the MLLM 150 generates an output, which can then be displayed or otherwise output (e.g., as audio) and/or processed by the application 146. For example, in some embodiments, the application 146 can display the output of the MLLM 150 via a user interface (UI) and a display device. As another example, in some embodiments, the application 146 can convert the output of the MLLM 150 to audio using a text-to-speech model and then output the audio via a speaker device.

FIG. 5A is a more detailed illustration of the fusion module 410 of FIG. 4, according to various embodiments. As shown, in some embodiments, the fusion module 410 can perform a channel-wise concatenation of the vision features, shown as vision maps 502 and 504, are output by vision encoders, namely vision experts 402, 404, 406, and 408, to generate a concatenated output 510. When the vision features generated by different vision encoders have different sizes, the fusion module 410 can re-size the vision features generated by one or more of the vision encoders so that the vision features are the same size (i.e., the resolutions are aligned), shown as flattened and re-sized vision features 506 and 508. For example, in some embodiments, vision features can be re-sized using interpolation (e.g., bilinear interpolation) or pixel shuffle. The flattened and re-sized vision features 506 and 508 that are the same size can then be concatenated in a channel-wise manner to generate the concatenated output 510. That is, the flattened and re-sized vision features 506 are concatenated along the channel dimension, without increasing the sequence length. Experience has shown that channel-wise concatenation provides better efficiency and performance than some other fusion strategies.

FIG. 5B is a more detailed illustration of the fusion module 410 of FIG. 4, according to various other embodiments. As shown, in some embodiments, the fusion module 410 can perform a deformable attention computation based on vision features that are output by vision encoders, namely vision experts 402, 404, 406, and 408. Deformable attention is a type of attention mechanism that permits a model to dynamically adjust a focus of the model on specific parts of input data by deforming the attention region based on the input features. Illustratively, the fusion module 410 obtains a transformer query 516 from a lower-resolution feature map 512 and a key and values 520ᵢ from a higher-resolution feature map 514. The fusion module 410 finds a position 518 in the higher-resolution feature map 514 that is co-located with the query 516 in the lower-resolution feature map 512, and the fusion module 410 (1) attends the position 518, which is a reference point, to the key and values 520ᵢ, which are sampling points, and (2) flattens the results to generate an output 522. The positions of the key and values 520ᵢ are learnable, as opposed to being fixed.

FIGS. 6A-6C illustrate how a MLLM that includes a mixture of vison encoders can be trained, according to various embodiments. FIG. 6A illustrates a first stage of training a MLLM that includes a mixture of vision encoders. As shown, the model trainer includes, without limitation, a generative loss module 610.

During the first stage of training, which is also referred to herein as “pre-alignment training,” the model trainer 116 trains vision-language models 602, 606, and 608 that each include a different vision encoder, shown as vision experts 402, 404, and 406, and a same LLM, shown as LLM 604. This example assumes the vision expert 408 does not need to be trained during the pre-training alignment because a visual representation of the vision expert 408 is already aligned with the text space through pre-training on image-text pairs, i.e., the vision expert 408 is already text aligned. In some embodiments, the LLM 604 can be a smaller LLM, with fewer parameters, than the LLM 414 of the MLLM 150. As described, the vision experts 402, 404, and 406 can be pre-trained for specific tasks. The LLM 604 can also be pretrained.

During pre-alignment training, the model trainer 116 trains the VLMs 602, 606, and 608 by updating parameters of the vision experts 402, 404, and 406, which are shown with a fire symbol, while keeping parameters of the LLM 604 fixed. In some embodiments, the vision experts 402, 404, and 406 can be trained with their own projectors (not shown), while keeping the LLM 604 frozen. In some embodiments, during pre-alignment training, the model trainer 116 can train the VLMs 602, 606, and 608 using a captioning dataset and an instruction following dataset as training data. In such cases, the captioning dataset includes a collection of images paired with textual descriptions (i.e., captions) that are used to train the VLMs 602, 606, and 608 to generate descriptive text for images. The instruction following dataset includes instructions or prompts paired with expected responses, which are used to train the VLMs 602, 606, and 608 to understand and follow instructions and/or answer questions. For example, the instruction following dataset could include vision question answering (VQA) data that includes images and text-based questions about the images, as well as expected answers to the questions. In some embodiments, the instructions or prompts and expected responses can be collected from different tasks and converted into multimodal conversations.

The generative loss module 610 compares an output generated by the LLM 604 in a VLM (only an output of the LLM 604 of VLM 608 is shown for illustrative purposes) against an expected output from the training data to compute a loss. For example, in some embodiments, a next-token prediction loss can be computed. Then, the model trainer 116 updates parameters of the vision encoder in the VLM based on the loss. The model trainer 116 can update parameters of the vision encoder in any technically feasible manner in some embodiments. The foregoing steps can also be repeated any number of times. For example, in some embodiments, the model trainer 116 can repeatedly update parameters of the vision encoder based on the loss via, for example, backpropagation with gradient descent or a variation thereof, until a stopping condition is met, such as training has been performed for a predefined number of iterations, the loss plateaus, or the like. Experience has shown that pre-alignment training can significantly improve the performance of a trained MLLM that includes a mixture of vision encoders. In particular, pre-alignment training addresses the gap between different vision encoders that create difficulties in training a combination of the different vision encoders by mitigating the inherent biases of each vision encoder and stabilizing the training, which can improve the overall performance of the trained MLLM. Pre-alignment training that first aligns individual vision encoders with the same LLM also fosters better synergy between visual and linguistic capabilities.

FIG. 6B illustrates a second stage of training a MLLM that includes a mixture of vision encoders. As shown, during the second stage of training, which is also referred to herein as “joint-projector training,” the model trainer 116 trains the MLLM 150 by updating parameters of the vision experts 402, 404, 406, and 408 and the projector 412, which are shown with a fire symbol, while keeping the tokenizer 413 and the LLM 414 fixed. Experience has shown that updating the parameters of the vision experts 402, 404, 406, and 408 along with the projector 412, as opposed to the traditional approach of keeping vision encoders fixed and only updating parameters of the projector, can improve the performance of the trained MLLM. In some embodiments, during joint-projector training, the model trainer 116 can train the MLLM 150 using as training data a captioning dataset and an instruction following dataset, such as the same captioning dataset and instruction following dataset that was used during pre-alignment training, described above in conjunction with FIG. 6A.

The generative loss module 610 compares an output generated by the LLM 414 against an expected output from the training data to compute a loss. For example, in some embodiments, a next-token prediction loss can be computed. Then, the model trainer 116 updates parameters of the vision experts 402, 404, 406, and 408 and the projector 412 based on the loss. The model trainer 116 can update the parameters in any technically feasible manner in some embodiments. The foregoing steps can also be repeated any number of times. For example, in some embodiments, the model trainer 116 can repeatedly update parameters of the vision experts 402, 404, 406, and 408 and the projector 412 based on the loss via, for example, backpropagation with gradient descent or a variation thereof, until a stopping condition is met, such as training has been performed for a predefined number of iterations, the loss plateaus, or the like.

FIG. 6C illustrates a third stage of training a MLLM that includes a mixture of vision encoders. As shown, during the third stage of training, which is a supervised fine-tuning stage, the model trainer 116 trains the MLLM 150 by updating parameters of the vision experts 402, 404, 406, and 408; the projector 412; the large language model 414; and the tokenizer 413, which are shown with a fire symbol. That is, the entire MLLM 150 is trained during the supervised fine-tuning stage. In some embodiments, during joint-projector training, the model trainer 116 can train the MLLM 150 using as training data an instruction following dataset, such as the instruction following dataset that was used during pre-alignment training and joint-projector training, described above in conjunction with FIGS. 6A-6B.

The generative loss module 610 compares an output generated by the LLM 414 against an expected output from the training data to compute a loss. For example, in some embodiments, a next-token prediction loss can be computed. Then, the model trainer 116 updates parameters of the vision experts 402, 404, 406, and 408; the projector 412; the large language model 414; and the tokenizer 413 based on the loss. The model trainer 116 can update the parameters in any technically feasible manner in some embodiments. Experience has shown that updating parameters of the vision experts 402, 404, 406, and 408 during supervised fine-tuning, as opposed to the traditional approach of keeping the vision experts fixed and only updating parameters of the LLM during supervised fine-tuning, enables better performance of the trained MLLM for larger input resolutions, such as resolutions greater than 336×336, as well as improved fusion performance using all of the vision experts 402, 404, 406, and 408 together. The foregoing steps can also be repeated any number of times. For example, in some embodiments, the model trainer 116 can repeatedly update parameters of the vision experts 402, 404, 406, and 408; the projector 412; the large language model 414; and the tokenizer 413 based on the loss via, for example, backpropagation with gradient descent or a variation thereof, until a stopping condition is met, such as training has been performed for a predefined number of iterations, the loss plateaus, or the like.

FIG. 7 is a more detailed illustration of the model generator 118 of FIG. 1, according to various embodiments. As shown, the model generator 118 includes, without limitation, a round robin module 702. In operation, the round robin module 702 uses a round robin search, which is a step-by-step greedy search strategy, to select vision encoders to include in MLLMs having different numbers of vision encoders, shown as MLLMs 704 and 706. Although two MLLMs 704 and 706 are shown for illustrative purposes, the model generator 118 can generate any number of MLLMs in some embodiments.

In some embodiments, for each round of the round robin search, the model generator 118 first selects, from a set of vision encoders, a vision encoder that has not yet been considered. The model generator 118 computes a performance score for a combination of the selected encoder with a current MLLM, if any. Each combination of a selected encoder with a current MLLM is a candidate MLLM for consideration. In some embodiments, the selection can be performed prior to training, and the performance score is computed after the MLLM that includes the combination of the selected encoder and the current MLLM is trained. The current MLLM will include a combination of vision encoders that were previously determined to perform the best when used together in a MLLM. The performance score can be computed using any technically feasible performance metric(s). For example, in some embodiments, the performance score can be computed as an average of metrics relating to visual question answering, OCR/document/chart understanding tasks, vision-centric tasks, and/or knowledge-based tasks. If the performance score computed by the model generator 118 is better than the performance score of a best performing combination of any previously considered vision encoder with the current MLLM, then the model generator 118 saves the combination of the selected encoder with the current MLLM as the best performing combination. Depending on the metric(s) used to compute the performance score, the computed performance score can be better by being either larger or smaller than the performance score of the best performing combination of any previously considered vision encoder with the current MLLM. For example, in some embodiments, a larger performance score can be considered better. The foregoing steps are repeated to consider all combinations of vision encoders in the set of vision encoders with the current MLLM to identify a best performing combination. The best performing combination can then be saved as the current MLLM, and the selected vision encoder that was used to generate the best performing combination can be removed from the set of vision encoders. Then, the model generator 118 considers all combinations of vision encoders remaining in the set of vision encoders with the new current MLLM to identify another best performing combination, etc. The model generator 118 can repeat the foregoing steps for any number of rounds of the round robin to generate a family of best performing MLLMs that include different numbers of vision encoders (e.g., a family that includes MLLMs 704 and 706). In some embodiments, the model generator 118 can stop iterating when a best performing MLLM that includes more vision encoders performs worse than a best performing MLLM that includes fewer vision encoders, or when all of the vision encoders have been considered and used in the family of MLLMs. One or more of the MLLMs in the family of MLLMs can then be deployed to various applications depending on, e.g., the available computing resources. For example, in applications that have access to fewer resources, an MLLM from the family of MLLMs that includes fewer vision encoders can be used, and vice versa.

Table 1 illustrates an example use of the round robin search, described above, to generate a family of MLLMs. In this example, vision encoder A corresponds to a CLIP (Contrastive Language-Image Pretraining) model, which is a pre-trained encoder having a vision transformer (ViT) large architecture; vision encoder B corresponds to a ConvNeXt model, which is pre-trained for a vision language alignment task; vision encoder C corresponds to a SAM (Segment Anything Model) model, which is pre-trained for a semantic segmentation task; vision encoder D corresponds to a DINOv2 (Self-Distillation with No Labels, version 2) model, which is pre-trained for a self-supervised learning task; vision encoder E corresponds to a Pix2Struct model, which is pre-trained for a text recognition task; vision encoder F corresponds to a EVA-02 (Embedding for Visual Alignment model, version 2) model, which is pre-trained for an object detection task. More generally, any suitable vision encoders can be used in some embodiments, including vision encoders that are pre-trained for different tasks.

Table 1 assumes that a MLLM that includes vision encoders A and B is known to be the best performing combination MLLM having two vision encoders. Starting from such a MLLM that includes vision encoders A+B as the current MLLM, the model generator 118 tries all combinations of vision encoders C, D, E, and F with the current MLLM, shown as combinations A+B+C, A+B+D, A+B+E, and A+B+F to identify a best performing combination, shown as the combination A+B+F. Then, starting from the MLLM that includes the vision encoders A+B+F as the current MLLM, the model generator 118 tries all combinations of the remaining vision encoders C, D, and E with the current MLLM, shown as combinations A+B+F+C, A+B+F+D, and A+B+F+E to identify a best performing combination, shown as the combination A+B+F+E. Then, starting from the MLLM that includes the vision encoders A+B+F+E as the current MLLM, the model generator 118 tries all combinations of the remaining vision encoders C and D with the current MLLM, shown as combinations A+B+F+E+C and A+B+F+E+D to identify a best performing combination, shown as the combination A+B+F+E+C. Then, starting from the MLLM that includes the vision encoders A+B+F+E+C as the current MLLM, the model generator 118 tries all combinations of the remaining vision encoders, which in this case is only the vision encoder D, to identify the best performing combination A+B+F+E+C+D. It should be noted that the performance score of the MLLM that includes the six vision encoders A+B+F+E+C+D is lower than the performance score for the MLLM that includes the five vision encoders A+B+F+E+C. As described, in some embodiments, the stopping condition for the round robin search can be when a best performing MLLM that includes more vision encoders (e.g., the MLLM that includes the six vision encoders A+B+F+E+C+D) performs worse than a best performing MLLM that includes fewer vision encoders (e.g., the MLLM that includes the five vision encoders A+B+F+E+C), or when all of the vision encoders have been considered and used in the family of MLLMs. In the example of Table 1, the round robin search produces a family of best performing MLLMs that include different numbers of vision encoders from the set of vision encoders A, B, C, D, E, and F, namely an MLLM that includes the two vision encoders A+B, an MLLM that includes the three vision encoders A+B+F, an MLLM that includes the four vision encoders A+B+F+E, an MLLM that includes the five vision encoders A+B+F+E+C, and an MLLM that includes the six vision encoders A+B+F+E+C+D.

TABLE 1

| # Encoders | Vision Encoder Combination | Performance Score |
|---|---|---|
| 2 | A + B | 681.5 |
| 3 | A + B + C | 685.4 |
| | A + B + D | 690.4 |
| | A + B + E | 685.1 |
| | A + B + F | 690.7 |
| 4 | A + B + F + C | 688.0 |
| | A + B + F + D | 689.4 |
| | A + B + F + E | 694.6 |
| 5 | A + B + F + E + C | 697.1 |
| | A + B + F + E + D | 684.7 |
| 6 | A + B + F + E + C + D | 686.8 |

FIG. 8 is a flow diagram of method steps for training a MLLM that includes a mixture of vision encoders, according to various embodiments. Although the method steps are described in conjunction with the systems of FIGS. 1-7, persons skilled in the art will understand that any system configured to perform the method steps in any order falls within the scope of the present embodiments.

As shown, a method 800 begins at step 802, where the model trainer 116 performs, using a captioning dataset and an instruction following dataset as training data, pre-alignment training of VLMs that each include a different vision encoder and the same LLM. As described, the captioning dataset can include a collection of images paired with textual descriptions (i.e., captions) that are used to train the VLMs to generate descriptive text for images. The instruction following dataset can include instructions or prompts paired with expected responses, which are used to train the VLMs to understand and follow instructions and/or answer questions. For example, the instruction following dataset could include vision VQA data that includes images and text-based questions about the images, as well as expected answers to the questions. In some embodiments, the instructions or prompts and expected responses can be collected from different tasks and converted into multimodal conversations. To train a VLM, the model trainer 116 compares an output generated by the LLM in the VLM against an expected output from the training data to compute a loss, such as a next token prediction loss. Then, the model trainer 116 updates parameters of the vision encoder in the VLM based on the loss, while keeping the LLM fixed. The foregoing steps can be repeated any number of times. For example, in some embodiments, the model trainer 116 can repeatedly update parameters of the vision encoder based on the loss via, for example, backpropagation with gradient descent or a variation thereof, until a stopping condition is met, such as training has been performed for a predefined number of iterations, the loss plateaus, or the like.

At step 804, the model trainer 116 performs, using the captioning dataset and the instruction following dataset as training data, joint-projector training of a MLLM that includes the different vision encoders and another LLM. As described, during the joint-projector training, the model trainer 116 updates parameters of the vision encoders and a projector in the MLLM, while keeping a tokenizer and the LLM in the MLLM fixed. In some embodiments, during joint-projector training, the model trainer 116 can train the MLLM using the same captioning dataset and instruction following dataset that were used during the pre-alignment training of step 802. The training can include comparing an output generated by the LLM in the MLLM against an expected output from the training data to compute a loss, such as a next token prediction loss. After computing the loss, the model trainer 116 updates parameters of the vision encoders and the projector in the MLLM, while keeping the tokenizer and the LLM in the MLLM fixed. The foregoing steps can be repeated any number of times. For example, in some embodiments, the model trainer 116 can repeatedly update parameters of the vision encoders and the projector in the MLLM based on the loss via, for example, backpropagation with gradient descent or a variation thereof, until a stopping condition is met, such as training has been performed for a predefined number of iterations, the loss plateaus, or the like.

At step 806, the model trainer 116 performs, using the instruction following dataset as training data, supervised fine-tuning of the MLLM. As described, during the supervised fine-tuning, the model trainer 116 updates parameters of the entire MLLM, including the vision encoders, projector, tokenizer, and LLM in the MLLM. In some embodiments, during joint-projector training, the model trainer 116 can train the MLLM using the same instruction following dataset that was used during the pre-alignment training of step 802 and the joint-projector training of step 804. The training can include comparing an output generated by the LLM in the MLLM against an expected output from the training data to compute a loss, such as a next token prediction loss. After computing the loss, the model trainer 116 updates parameters of the entire MLLM. The foregoing steps can be repeated any number of times. For example, in some embodiments, the model trainer 116 can repeatedly update parameters of the vision encoders and the projector in the MLLM based on the loss via, for example, backpropagation with gradient descent or a variation thereof, until a stopping condition is met, such as training has been performed for a predefined number of iterations, the loss plateaus, or the like.

FIG. 9 is a flow diagram of method steps for generating a family of MLLMs that include different numbers of vision encoders, according to various embodiments. Although the method steps are described in conjunction with the systems of FIGS. 1-7, persons skilled in the art will understand that any system configured to perform the method steps in any order falls within the scope of the present embodiments.

As shown, a method 900 begins at step 902, where the model generator 118 selects, from a set of vision encoders, a vision encoder that has not yet been considered. In some embodiments, the set of vision encoders can include vision encoders that are pre-trained for different tasks, such as a vision language alignment task, a text recognition task, an object detection task, a semantic segmentation task, and/or an OCR task. In some embodiments, the vision encoders can also be pre-trained to process images having the same or different resolutions.

At step 904, the model generator 118 computes a performance score for a combination of the selected encoder with a current MLLM. In some embodiments, the selection at step 902 can be performed prior to training, and the performance score can be computed after the MLLM that includes the combination of the selected encoder and the current MLLM is trained. The current MLLM includes a combination of vision encoders that were previously determined to perform the best when used together in a MLLM. The performance score can be computed using any technically feasible performance metric(s). For example, in some embodiments, the performance score can be computed as an average of metrics relating to visual question answering, OCR/document/chart understanding tasks, vision-centric tasks, and/or knowledge-based tasks.

At step 906, if the computed performance score is better than the performance score of the best performing previously considered combination of a vision encoder from the set of vision encoders with the current MLLM, if any, then at step 908, the model generator 118 saves the combination of the selected encoder with the current MLLM as the best performing combination. Depending on the metric(s) used to compute the performance score, the computed performance score can be better by being either larger or smaller than the performance score of the best performing combination. For example, in some embodiments, a larger performance score can be considered better.

At step 910, if there are more vision encoders in the set of vision encoders to consider, then the method 900 returns to step 902, where the model generator selects, from the set of vision encoders, another vision encoder that has not yet been considered. On the other hand, if there are no more vision encoders in the set of vision encoders to consider, then at step 912, the model generator 118 saves the best performing combination as one MLLM in a family of MLLMs, sets the best performing combination as the current MLLM, and removes the vision encoder in the best performing combination from the set of vision encoders.

At step 914, if there are more vision encoders in the set of vision encoders to consider, then the method 900 returns to step 902, where the model generator selects, from the set of vision encoders, another vision encoder that has not yet been considered. On the other hand, if there are no more vision encoders in the set of vision encoders to consider, then the method 900 ends. In some other embodiments, the model generator 118 can stop iterating when a best performing MLLM that includes more vision encoders performs worse than a best performing MLLM that includes fewer vision encoders.

FIG. 10 is a flow diagram of method steps for processing inputs using a trained MLLM that includes a mixture of vision encoders, according to various embodiments. Although the method steps are described in conjunction with the systems of FIGS. 1-7, persons skilled in the art will understand that any system configured to perform the method steps in any order falls within the scope of the present embodiments.

As shown, a method 1000 begins at step 1002, where the application 146 receives an image and a text input. For example, the text input could be a question or instruction relating to the image.

At step 1004, the application 146 processes the image and the text input using a trained MLLM that includes a mixture of vision encoders to generate an output. In some embodiments, the trained MLLM can include a combination of vision encoders determined according to the method 900 described above in conjunction with FIG. 9. In some embodiments, the trained MLLM can be trained according to the method 800 described above in conjunction with FIG. 8.

At step 1006, the application 146 displays the output via a UI. Although shown as displaying the output for illustrative purposes, in some embodiments, the application 146 can output and/or further process the output of the trained MLLM in any technically feasible manner. For example, in some embodiments, the application 146 can output the output of the trained MLLM as audio using a text-to-speech model and a speaker device.

In sum, techniques are disclosed for generating and training MLLMs that include a mixture of vision encoders. In some embodiments, a model trainer trains a MLLM that includes multiple vision encoders, which can be pre-trained for different tasks and image sizes, in three stages. In the first stage, referred to herein as “pre-alignment training,” the model trainer performs, using a captioning dataset and an instruction following dataset as training data, training of multiple vision-language models that each include a different vision encoder and the same LLM. The training in the first stage can include updating parameters of the different vision encoders, while keeping parameters of the LLM fixed. In the second stage, referred to herein as “joint-projector training,” the model trainer trains a MLLM that includes the different vision encoders and another LLM using the captioning dataset and the instruction following dataset as training data. The training in the second stage can include updating parameters of the different vision encoders and a projector that projects vision features output by the vision encoders to language embedding tokens in a word embedding space of the LLM, while keeping parameters of a tokenizer and the LLM fixed. In the third stage, which is referred to herein as “supervised fine-tuning,” the model trainer trains the MLLM using the instruction following dataset as training data. The training in the third stage can include updating parameters of the vision encoders, the projector, the large language model, and the tokenizer.

In some embodiments, a model generator generates a family of MLLMs that include different numbers of vision encoders using a round robin search. In the round robin search, the model generator first selects, from a set of vision encoders, a vision encoder that has not yet been considered. The model generator computes a performance score for a combination of the selected encoder with a current MLLM, if any. In some embodiments, the selection can be performed prior to training, and the performance score is computed after the MLLM that includes the combination of the selected encoder and the current MLLM is trained. The current MLLM will include a combination of vision encoders that were previously determined to perform the best when used together in a MLLM. If the performance score computed by the model generator is better than the performance score of a best performing combination of any previously considered vision encoder with the current MLLM, then the model generator saves the combination of the selected encoder with the current MLLM as the best performing combination. The foregoing steps are repeated to consider all combinations of vision encoders in the set of vision encoders with the current MLLM to identify a best performing combination. The best performing combination can then be saved as the current MLLM, and the selected vision encoder that was used to generate the best performing combination can be removed from the set of vision encoders. Then, the model generator considers all combinations of vision encoders remaining in the set of vision encoders with the new current MLLM to identify another best performing combination, etc. By repeating the foregoing steps, the model generator can generate a family of best performing MLLMs that include different numbers of vision encoders. In some embodiments, the stopping condition for the round robin search can be when a best performing MLLM that includes more vision encoders performs worse than a best performing MLLM that includes fewer vision encoders, or when all of the vision encoders have been considered and used in the family of MLLMs. One or more of the MLLMs in the family of MLLMs can then be deployed to various applications depending on, e.g., the available computing resources.

At least one technical advantage of the disclosed techniques relative to the prior art is that, with the disclosed techniques, MLLMs can be trained to perceive and understand smaller details in images that are input into the MLLMs. In addition, the trained MLLMs can generate, for images and text that are input into the MLLMs, more correct outputs relative to what can be generated by conventional MLLMs. These technical advantages represent one or more technological improvements over prior art approaches.

1. In some embodiments, a computer-implemented method for training multimodal models comprises performing one or more operations to train a plurality of vision language models to generate a plurality of trained vision language models, wherein each trained vision language model included in the plurality of trained vision language models comprises a different vision encoder and a first language model, and performing one or more operations to train a multimodal model to generate a trained multimodal model, wherein the trained multimodal model comprises the different vision encoders and a second language model.

2. The computer-implemented method of clause 1, wherein performing one or more operations to train the multimodal model comprises performing one or more first training operations to update one or more parameters of the different vision encoders and one or more parameters of a projector included in the multimodal model, and performing one or more second training operations to update one or more parameters of the different vision encoders, one or more parameters of the projector, and one or more parameters of the second language model.

3. The computer-implemented method of clauses 1 or 2, wherein the one or more first training operations are based on a first data set that includes one or more images associated with one or more captions and a second data set that includes one or more instructions and one or more corresponding outputs, and wherein the one or more second training operations are based on the second data set.

4. The computer-implemented method of any of clauses 1-3, wherein the one or more operations to train the plurality of vision language models are based on a first data set that includes one or more images associated with one or more captions and a second data set that includes one or more instructions and one or more corresponding outputs.

5. The computer-implemented method of any of clauses 1-4, wherein the different vision encoders include one or more vision encoders that are trained for at least one of a vision language alignment task, a text recognition task, an object detection task, or a semantic segmentation task.

6. The computer-implemented method of any of clauses 1-5, wherein performing one or more operations to train the plurality of vision language models comprises updating one or more parameters of the different vision encoders without updating one or more parameters of the first language model.

7. The computer-implemented method of any of clauses 1-6, wherein the first language model includes fewer parameters than the second language model.

8. The computer-implemented method of any of clauses 1-7, wherein the trained multimodal model further comprises a fusion module that performs channel-wise concatenation on a plurality of features generated by the different vision encoders.

9. The computer-implemented method of any of clauses 1-8, wherein the trained multimodal model further comprises a fusion module that computes a deformable attention based on a plurality of features generated by the different vision encoders.

10. The computer-implemented method of any of clauses 1-9, further comprising processing at least one of an input image or input text via the trained multimodal model to generate a text output, and outputting the text output via at least one of a display device or a speaker device.

11. In some embodiments, one or more non-transitory computer-readable storage media include instructions that, when executed by at least one processor, cause the at least one processor to perform steps for training multimodal models, the steps comprising performing one or more operations to train a plurality of vision language models to generate a plurality of trained vision language models, wherein each trained vision language model included in the plurality of trained vision language models comprises a different vision encoder and a first language model, and performing one or more operations to train a multimodal model to generate a trained multimodal model, wherein the trained multimodal model comprises the different vision encoders and a second language model.

12. The one or more non-transitory computer-readable storage media of clause 11, wherein performing one or more operations to train the multimodal model comprises performing one or more first training operations to update one or more parameters of the different vision encoders and one or more parameters of a projector included in the multimodal model, and performing one or more second training operations to update one or more parameters of the different vision encoders, one or more parameters of the projector, and one or more parameters of the second language model.

13. The one or more non-transitory computer-readable storage media of clauses 11 or 12, wherein the one or more first training operations are based on a first data set that includes one or more images associated with one or more captions and a second data set that includes one or more instructions and one or more corresponding outputs, and wherein the one or more second training operations are based on the second data set.

14. The one or more non-transitory computer-readable storage media of any of clauses 11-13, wherein the one or more operations to train the plurality of vision language models are based on a first data set that includes one or more images associated with one or more captions and a second data set that includes one or more instructions and one or more corresponding outputs.

15. The one or more non-transitory computer-readable storage media of any of clauses 11-14, wherein the trained multimodal model further comprises a fusion module that performs channel-wise concatenation on a plurality of features generated by the different vision encoders.

16. The one or more non-transitory computer-readable storage media of any of clauses 11-15, wherein the trained multimodal model comprises a trained multimodal large language model.

17. The one or more non-transitory computer-readable storage media of any of clauses 11-16, wherein the one or more operations to train the multimodal model comprise one or more joint-projector training operations and one or more supervised fine-tuning operations.

18. The one or more non-transitory computer-readable storage media of any of clauses 11-17, wherein the different vision encoders include a plurality of vision encoders that are each trained for one of a vision language alignment task, a text recognition task, an object detection task, or a semantic segmentation task.

19. The one or more non-transitory computer-readable storage media of any of clauses 11-18, wherein the different vision encoders include a vision encoder having a vision transformer (ViT) large architecture.

20. In some embodiments, a system comprises one or more memories storing instructions, and one or more processors that are coupled to the one or more memories and, when executing the instructions, are configured to perform one or more operations to train a plurality of vision language models to generate a plurality of trained vision language models, wherein each trained vision language model included in the plurality of trained vision language models comprises a different vision encoder and a first language model, and perform one or more operations to train a multimodal model to generate a trained multimodal model, wherein the trained multimodal model comprises the different vision encoders and a second language model.

1. In some embodiments, a computer-implemented method for generating a family of multimodal models for execution based on computer system resources comprises generating a plurality of candidate multimodal models by combining a previously-generated multimodal model with a plurality of vision encoders, wherein each candidate multimodal model comprises the previously-generated multimodal model and a different one of the vision encoders included in the plurality of vision encoders, computing a performance score for each candidate multimodal model, determining that a first candidate multimodal model included in the plurality of candidate multimodal models is associated with a first performance score that is better than all other performance scores associated with all other candidate multimodal models included in the plurality of candidate multimodal models, and selecting the first candidate multimodal model for inclusion in the family of multimodal models, wherein each multimodal model included in the family of multimodal models incorporates a number of vision encoders that is different than a number of vision encoders incorporated into all other multimodal models included in the family of multimodal models, wherein at least one multimodal model included in the family of multimodal models is subsequently executed for at least one application based on one or more hardware resources associated with a first computer system.

2. The computer-implemented method of clause 1, further comprising computing the first performance score based on at least one of a visual question answering metric, an optical character recognition task metric, a document understanding task metric, a chart understanding task metric, a vision-centric task metric, or a knowledge-based task metric.

3. The computer-implemented method of clauses 1 or 2, wherein generating each candidate multimodal model included in the plurality of candidate multimodal models comprises performing one or more training operations to generate a plurality of vision language models that each comprise a different trained vision encoder and a first trained language model, and performing one or more training operations to generate the candidate multimodal model that comprises all of the different trained vision encoders and a second trained language model.

4. The computer-implemented method of any of clauses 1-3, wherein selecting the first candidate multimodal model is further based on the first performance score being higher than a second performance score associated with the previously-generated multimodal model.

5. The computer-implemented method of any of clauses 1-4, further comprising generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders, computing a performance score for each candidate multimodal model included in the another plurality of candidate multimodal models, determining a second candidate multimodal model included in the another plurality of candidate multimodal models is associated with a second performance score that is worse than the first performance score, and not selecting the second candidate multimodal model for inclusion in the family of multimodal models.

6. The computer-implemented method of any of clauses 1-5, wherein the first candidate multimodal model comprises a first vision encoder having a vision transformer large architecture and a second vision encoder that is pre-trained for a vision alignment task.

7. The computer-implemented method of any of clauses 1-6, wherein the first candidate multimodal model comprises a first vision encoder having a vision transformer large architecture, a second vision encoder that is pre-trained for a vision alignment task, and a third vision encoder that is pre-trained for an object detection task.

8. The computer-implemented method of any of clauses 1-7, wherein the first candidate multimodal model comprises a first vision encoder having a vision transformer large architecture, a second vision encoder that is pre-trained for a vision alignment task, a third vision encoder that is pre-trained for an object detection task, and a fourth vision encoder that is pre-trained for a text recognition task.

9. The computer-implemented method of any of clauses 1-8, wherein the first candidate multimodal model comprises a first vision encoder having a vision transformer large architecture, a second vision encoder that is pre-trained for a vision alignment task, a third vision encoder that is pre-trained for an object detection task, a fourth vision encoder that is pre-trained for a text recognition task, and a fifth vision encoder that is pre-trained for a semantic segmentation task.

10. The computer-implemented method of any of clauses 1-9, wherein the first candidate multimodal model comprises a first vision encoder having a vision transformer large architecture, a second vision encoder that is pre-trained for a vision alignment task, a third vision encoder that is pre-trained for an object detection task, a fourth vision encoder that is pre-trained for a text recognition task, a fifth vision encoder that is pre-trained for a semantic segmentation task, and a sixth vision encoder that is pre-trained for a self-supervised learning task.

11. In some embodiments, one or more non-transitory computer-readable storage media include instructions that, when executed by at least one processor, cause the at least one processor to perform steps comprising generating a plurality of candidate multimodal models by combining a previously-generated multimodal model with a plurality of vision encoders, wherein each candidate multimodal model comprises the previously-generated multimodal model and a different one of the vision encoders included in the plurality of vision encoders, computing a performance score for each candidate multimodal model, determining that a first candidate multimodal model included in the plurality of candidate multimodal models is associated with a first performance score that is better than all other performance scores associated with all other candidate multimodal models included in the plurality of candidate multimodal models, and selecting the first candidate multimodal model for inclusion in a family of multimodal models, wherein each multimodal model included in the family of multimodal models incorporates a number of vision encoders that is different than a number of vision encoders incorporated into all other multimodal models included in the family of multimodal models, wherein at least one multimodal model included in the family of multimodal models is subsequently executed for at least one application based on one or more hardware resources associated with a first computer system.

12. The one or more non-transitory computer-readable storage media of clause 11, wherein the instructions, when executed by at least one processor, further cause the at least one processor to perform the step of computing the first performance score based on at least one of a visual question answering metric, an optical character recognition task metric, a document understanding task metric, a chart understanding task metric, a vision-centric task metric, or a knowledge-based task metric.

13. The one or more non-transitory computer-readable storage media of clauses 11 or 12, wherein the instructions, when executed by at least one processor, further cause the at least one processor to perform the steps of generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders, computing a performance score for each candidate multimodal model included in the another plurality of candidate multimodal models, determining that a second candidate multimodal model included in the another plurality of candidate multimodal models is associated with a second performance score that is better than all other performance scores associated with all other candidate multimodal models included in the another plurality of candidate multimodal models, and selecting the second candidate multimodal model for inclusion in the family of multimodal models.

14. The one or more non-transitory computer-readable storage media of any of clauses 11-13, wherein the first candidate multimodal model comprises a multimodal large language model (MLLM).

15. The one or more non-transitory computer-readable storage media of any of clauses 11-14, wherein the instructions, when executed by at least one processor, further cause the at least one processor to perform the steps of generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders, computing a performance score for each candidate multimodal model included in the another plurality of candidate multimodal models, determining a second candidate multimodal model included in the another plurality of candidate multimodal models is associated with a second performance score that is worse than the first performance score, and not selecting the second candidate multimodal model for inclusion in the family of multimodal models.

16. The one or more non-transitory computer-readable storage media of any of clauses 11-15, wherein the first candidate multimodal model comprises a first vision encoder having a vision transformer large architecture and a second vision encoder that is pre-trained for a vision alignment task.

17. The one or more non-transitory computer-readable storage media of any of clauses 11-16, wherein the first candidate multimodal model comprises a first vision encoder having a vision transformer large architecture, a second vision encoder that is pre-trained for a vision alignment task, and a third vision encoder that is pre-trained for an object detection task.

18. The one or more non-transitory computer-readable storage media of any of clauses 11-17, wherein the first candidate multimodal model comprises a first vision encoder having a vision transformer large architecture, a second vision encoder that is pre-trained for a vision alignment task, a third vision encoder that is pre-trained for an object detection task, and a fourth vision encoder that is pre-trained for a text recognition task.

19. The one or more non-transitory computer-readable storage media of any of clauses 11-18, wherein the first candidate multimodal model comprises a plurality of vision encoders that are pre-trained for different tasks.

20. In some embodiments, a system comprises one or more memories storing instructions, and one or more processors that are coupled to the one or more memories and, when executing the instructions, are configured to generate a plurality of candidate multimodal models by combining a previously-generated multimodal model with a plurality of vision encoders, wherein each candidate multimodal model comprises the previously-generated multimodal model and a different one of the vision encoders included in the plurality of vision encoders, compute a performance score for each candidate multimodal model, determine that a first candidate multimodal model included in the plurality of candidate multimodal models is associated with a first performance score that is better than all other performance scores associated with all other candidate multimodal models included in the plurality of candidate multimodal models, and select the first candidate multimodal model for inclusion in the family of multimodal models, wherein each multimodal model included in the family of multimodal models incorporates a number of vision encoders that is different than a number of vision encoders incorporated into all other multimodal models included in the family of multimodal models, wherein at least one multimodal model included in the family of multimodal models is subsequently executed for at least one application based on one or more hardware resources associated with a first computer system.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a family of multimodal models for execution based on computer system resources, the method comprising:
generating a plurality of candidate multimodal models by combining a previously-generated multimodal model with a plurality of vision encoders, wherein each candidate multimodal model comprises the previously-generated multimodal model and a different one of the vision encoders included in the plurality of vision encoders;
computing a performance score for each candidate multimodal model;
determining that a first candidate multimodal model included in the plurality of candidate multimodal models is associated with a first performance score that is better than all other performance scores associated with all other candidate multimodal models included in the plurality of candidate multimodal models; and
selecting the first candidate multimodal model for inclusion in the family of multimodal models, wherein each multimodal model included in the family of multimodal models incorporates a number of vision encoders that is different than a number of vision encoders incorporated into all other multimodal models included in the family of multimodal models,
wherein at least one multimodal model included in the family of multimodal models is subsequently executed for at least one application based on one or more hardware resources associated with a first computer system.

2. The computer-implemented method of claim 1, further comprising computing the first performance score based on at least one of a visual question answering metric, an optical character recognition task metric, a document understanding task metric, a chart understanding task metric, a vision-centric task metric, or a knowledge-based task metric.

3. The computer-implemented method of claim 1, wherein generating each candidate multimodal model included in the plurality of candidate multimodal models comprises:
performing one or more training operations to generate a plurality of vision language models that each comprise a different trained vision encoder and a first trained language model; and
performing one or more training operations to generate the candidate multimodal model that comprises all of the different trained vision encoders and a second trained language model.

4. The computer-implemented method of claim 1, wherein selecting the first candidate multimodal model is further based on the first performance score being higher than a second performance score associated with the previously-generated multimodal model.

5. The computer-implemented method of claim 1, further comprising:
generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders;
computing a performance score for each candidate multimodal model included in the another plurality of candidate multimodal models;
determining a second candidate multimodal model included in the another plurality of candidate multimodal models is associated with a second performance score that is worse than the first performance score; and
not selecting the second candidate multimodal model for inclusion in the family of multimodal models.

6. The computer-implemented method of claim 1, wherein the first candidate multimodal model comprises a first vision encoder having a vision transformer large architecture and a second vision encoder that is pre-trained for a vision alignment task.

7. The computer-implemented method of claim 1, wherein the first candidate multimodal model comprises a first vision encoder having a vision transformer large architecture, a second vision encoder that is pre-trained for a vision alignment task, and a third vision encoder that is pre-trained for an object detection task.

8. The computer-implemented method of claim 1, wherein the first candidate multimodal model comprises a first vision encoder having a vision transformer large architecture, a second vision encoder that is pre-trained for a vision alignment task, a third vision encoder that is pre-trained for an object detection task, and a fourth vision encoder that is pre-trained for a text recognition task.

9. The computer-implemented method of claim 1, wherein the first candidate multimodal model comprises a first vision encoder having a vision transformer large architecture, a second vision encoder that is pre-trained for a vision alignment task, a third vision encoder that is pre-trained for an object detection task, a fourth vision encoder that is pre-trained for a text recognition task, and a fifth vision encoder that is pre-trained for a semantic segmentation task.

10. The computer-implemented method of claim 1, wherein the first candidate multimodal model comprises a first vision encoder having a vision transformer large architecture, a second vision encoder that is pre-trained for a vision alignment task, a third vision encoder that is pre-trained for an object detection task, a fourth vision encoder that is pre-trained for a text recognition task, a fifth vision encoder that is pre-trained for a semantic segmentation task, and a sixth vision encoder that is pre-trained for a self-supervised learning task.

11. One or more non-transitory computer-readable storage media including instructions that, when executed by at least one processor, cause the at least one processor to perform steps comprising:
generating a plurality of candidate multimodal models by combining a previously-generated multimodal model with a plurality of vision encoders, wherein each candidate multimodal model comprises the previously-generated multimodal model and a different one of the vision encoders included in the plurality of vision encoders;
computing a performance score for each candidate multimodal model;
determining that a first candidate multimodal model included in the plurality of candidate multimodal models is associated with a first performance score that is better than all other performance scores associated with all other candidate multimodal models included in the plurality of candidate multimodal models; and
selecting the first candidate multimodal model for inclusion in a family of multimodal models, wherein each multimodal model included in the family of multimodal models incorporates a number of vision encoders that is different than a number of vision encoders incorporated into all other multimodal models included in the family of multimodal models,
wherein at least one multimodal model included in the family of multimodal models is subsequently executed for at least one application based on one or more hardware resources associated with a first computer system.

12. The one or more non-transitory computer-readable storage media of claim 11, wherein the instructions, when executed by at least one processor, further cause the at least one processor to perform the step of computing the first performance score based on at least one of a visual question answering metric, an optical character recognition task metric, a document understanding task metric, a chart understanding task metric, a vision-centric task metric, or a knowledge-based task metric.

13. The one or more non-transitory computer-readable storage media of claim 11, wherein the instructions, when executed by at least one processor, further cause the at least one processor to perform the steps of:
generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders;
computing a performance score for each candidate multimodal model included in the another plurality of candidate multimodal models;
determining that a second candidate multimodal model included in the another plurality of candidate multimodal models is associated with a second performance score that is better than all other performance scores associated with all other candidate multimodal models included in the another plurality of candidate multimodal models; and
selecting the second candidate multimodal model for inclusion in the family of multimodal models.

14. The one or more non-transitory computer-readable storage media of claim 11, wherein the first candidate multimodal model comprises a multimodal large language model (MLLM).

15. The one or more non-transitory computer-readable storage media of claim 11, wherein the instructions, when executed by at least one processor, further cause the at least one processor to perform the steps of:
generating another plurality of candidate multimodal models by combining the first candidate multimodal model with another plurality of vision encoders, wherein each candidate multimodal model included in the another plurality of candidate multimodal models comprises the first candidate multimodal model and a different one of the vision encoders included in the another plurality of vision encoders;
computing a performance score for each candidate multimodal model included in the another plurality of candidate multimodal models;
determining a second candidate multimodal model included in the another plurality of candidate multimodal models is associated with a second performance score that is worse than the first performance score; and
not selecting the second candidate multimodal model for inclusion in the family of multimodal models.

16. The one or more non-transitory computer-readable storage media of claim 11, wherein the first candidate multimodal model comprises a first vision encoder having a vision transformer large architecture and a second vision encoder that is pre-trained for a vision alignment task.

17. The one or more non-transitory computer-readable storage media of claim 11, wherein the first candidate multimodal model comprises a first vision encoder having a vision transformer large architecture, a second vision encoder that is pre-trained for a vision alignment task, and a third vision encoder that is pre-trained for an object detection task.

18. The one or more non-transitory computer-readable storage media of claim 11, wherein the first candidate multimodal model comprises a first vision encoder having a vision transformer large architecture, a second vision encoder that is pre-trained for a vision alignment task, a third vision encoder that is pre-trained for an object detection task, and a fourth vision encoder that is pre-trained for a text recognition task.

19. The one or more non-transitory computer-readable storage media of claim 11, wherein the first candidate multimodal model comprises a plurality of vision encoders that are pre-trained for different tasks.

20. A system, comprising:
one or more memories storing instructions; and
one or more processors that are coupled to the one or more memories and, when executing the instructions, are configured to:
generate a plurality of candidate multimodal models by combining a previously-generated multimodal model with a plurality of vision encoders, wherein each candidate multimodal model comprises the previously-generated multimodal model and a different one of the vision encoders included in the plurality of vision encoders,
compute a performance score for each candidate multimodal model,
determine that a first candidate multimodal model included in the plurality of candidate multimodal models is associated with a first performance score that is better than all other performance scores associated with all other candidate multimodal models included in the plurality of candidate multimodal models, and
select the first candidate multimodal model for inclusion in the family of multimodal models, wherein each multimodal model included in the family of multimodal models incorporates a number of vision encoders that is different than a number of vision encoders incorporated into all other multimodal models included in the family of multimodal models,
wherein at least one multimodal model included in the family of multimodal models is subsequently executed for at least one application based on one or more hardware resources associated with a first computer system.
